(19) United States
(12) Patent Application Publication
(10) Pub. No.: US 2024/0133292 A1
(43) Pub. Date: Apr. 25, 2024

(54) METHOD FOR PREDICTING EVOLUTION LAW OF ROCK MECHANICAL STRATUM OF FRACTURED RESERVOIR

(71) Applicant: CHINA UNIVERSITY OF GEOSCIENCES (WUHAN), Wuhan (CN)

(72) Inventors: Jingshou LIU, Wuhan (CN); Lianfu MEI, Wuhan (CN); Lin SHANG, Wuhan (CN); Chuanbo SHEN, Wuhan (CN); Zhonghu WU, Wuhan (CN); Peng CHEN, Wuhan (CN); Ruyue WANG, Wuhan (CN); Hejuan LIU, Wuhan (CN)

(73) Assignee: CHINA UNIVERSITY OF GEOSCIENCES (WUHAN), Wuhan (CN)

(21) Appl. No.: 18/305,364

(22) Filed: Apr. 23, 2023

(30) Foreign Application Priority Data
Apr. 26, 2022 (CN) 202210445663.9

(51) Int. Cl. E21B 49/00; E21B 43/26

(52) U.S. Cl. CPC E21B 49/006; E21B 43/26; E21B 2200/20

(57) ABSTRACT

A method for predicting an evolution law of a rock mechanical stratum of a fractured reservoir is provided. A three-dimensional heterogeneous model of mechanical parameters of an intact rock is built by means of a core experiment, logging calculation and seismic inversion; a three-dimensional discrete fracture network geomechanical model is built by means of field observation; effects of fracture parameters on magnitudes and anisotropy of mechanical parameters of a fractured rock mass are analyzed by means of numerical simulation; and a paleo-stress field, and a fracture density and occurrence at different periods are simulated in successive cycles in combination with a relation between the fracture parameters of a reservoir and rock mechanical parameters as well as a stress field, and a migration law of the rock mechanical stratum under the control of a tectonic factor is interpreted.

### CROSS-REFERENCE TO RELATED APPLICATIONS

This application claims priority to Chinese Patent Application No. 202210445663.9 with a filing date of Apr. 26, 2022. The content of the aforementioned application, including any intervening amendments thereto, is incorporated herein by reference.

### TECHNICAL FIELD

The present disclosure relates to the field of exploration and development of oil and gas fields, and in particular to a method for predicting an evolution law of a rock mechanical stratum of a fractured reservoir.

### BACKGROUND

With the discovery of an increasing number of fractured oil and gas reservoirs, three-dimensional distributions of a crustal stress and a natural fracture, which play a crucial role in controlling exploration and development of a fractured reservoir, have attracted wide attention of researchers. Currently, a reservoir geomechanical method is most commonly used for modeling the crustal stress and predicting a tectonic fracture, and has also been effectively used in a tight sandstone reservoir, a shale reservoir and a low-permeability sandstone reservoir. Accurate characterization of a rock mechanical stratum is crucial to effectively use reservoir geomechanical modeling, which determines accuracy of predicting a reservoir fracture and modeling the crustal stress. The rock mechanical stratum refers to a set of rock strata having consistent rock mechanical properties or similar rock mechanical behaviors. However, the rock mechanical stratum is not necessarily homogeneous in lithology, and thus does not completely correspond to a lithologic stratum. For a long time in the past, a fractured stratum was a synonym for the rock mechanical stratum. However, the fractured stratum reflects a paleo-rock mechanical stratum in a period of rock rupture. Affected by both diagenesis and tectonism, rock properties will change with time. A rock mechanical stratum that controls fracture development and a rock mechanical stratum that is suitable for predicting the natural fracture are less likely to exist.

The rock mechanical stratum controls a development degree and a formation mechanism of the natural fracture. Similarly, magnitudes and anisotropy of rock mechanical parameters will be tied to fracture development. Affected by both the diagenesis and the tectonism, the rock mechanical stratum will migrate. Therefore, coincidence between the rock mechanical stratum and the lithologic stratum as well as the fractured stratum is neither necessary nor typical. The rock mechanical stratum that controls the fracture development and the rock mechanical stratum that is suitable for predicting distribution of the natural fracture are less likely to exist. Research on an evolution law of the rock mechanical stratum is a new beginning for a next-generation of reservoir fracture research. The patent of the present disclosure provides, according to the reservoir geomechanical method, a method for predicting an evolution law of a rock mechanical stratum of a fractured reservoir under the control of a tectonic factor.

### SUMMARY OF PRESENT INVENTION

The objective of the present disclosure is to provide a method for predicting an evolution law of a rock mechanical stratum of a fractured reservoir, which quantitatively predicts the evolution law of the rock mechanical stratum of the fractured reservoir under the control of a tectonic factor.

The technical solution of the present disclosure is as follows: a method for predicting an evolution law of a rock mechanical stratum of a fractured reservoir includes (as shown in FIG. 1):

Step 1, determining a formation period of tectonic fractures with a geologic analysis and fluid geochemical method, where the determining a formation period of tectonic fractures with a geologic analysis and fluid geochemical method includes carrying out, on the basis of identification and characterization research on fractures of different scales, experimental research on a fluid geochemical evidence of the activity of the reservoir fractures on the basis of multi-stage filling features of the fractures, and carrying out observation photography, microscopic temperature measurement and laser Raman spectrum test on fluid inclusions in reservoir fracture filling minerals, to determine a type, shape, phase state, abundance, salinity, composition and homogenized temperature of the fluid inclusions, Fe₂O₃, MgO, MgO₂, trace elements, carbon and oxygen isotopes, and composition and salinity of stratum water, calculating a capture pressure and density of the fluid inclusions, comparatively analyzing differences in paleo-fluid properties of different types of filling minerals, and comprehensively determining stages of the activity of the reservoir fractures in combination with an intersecting relation of fractures in different rock formations; and setting a stage of activity of reservoir fractures as N.

Step 2, carrying out a rock acoustic emission experiment on a rock sample having undeveloped fractures, so as to determine magnitudes of a paleo-stress and a current stress in the formation period of the tectonic fractures; and measuring an acoustic signal emitted from an interior of rock under a load with an acoustic emission instrument, and according to a principle of a Kaiser effect, determining a value of a crustal stress on the rock underground on the basis that the acoustic signal generated by the rock is suddenly amplified when a stress on the rock reaches a historical maximum stress of the rock.

Step 3, on the basis of a uniaxial compression experiment, a triaxial compression experiment and calculation of logging data, determining mechanical parameters of an intact rock having undeveloped fractures by means of uniaxial-triaxial and dynamic-static correction of rock mechanical parameters, thereby providing a data basis for numerical simulation of a stress field and prediction of the reservoir fractures.

Currently, there are mainly two methods for measuring rock mechanical parameters. One method is a rock mechanical experiment of a rock sample in a laboratory, and includes a uniaxial compression experiment and a triaxial compression experiment, where results obtained are usually called as static parameters. The other method is to perform calculation by utilizing geophysical data in combination with corresponding calculation models, and results obtained are called as dynamic parameter. In addition, the rock mechanical parameters may be obtained by utilizing hydraulic fracturing data. In a practical engineering application, the static rock mechanical parameters are usually used. In the static parameters, the triaxial compression experiment is closer to an actual environment of the underground rock than the uniaxial compression experiment, has higher accuracy, and thus is a main basis for the rock mechanical parameters used in the numerical simulation of the crustal stress and the reservoir fractures.

The uniaxial compression experiment and the triaxial compression experiment of the rock directly utilizes an underground core, which belong to direct data and have high accuracy and reliability in theory. However, due to the small number of sample points, the results obtained directly for numerical simulation lack sufficient theoretical basis, have high experimental cost, and are economically uneconomical. The logging data makes up for defects of the rock mechanical experiment to some extent, and has the advantages of excellent continuity and low cost.

Interpretation of the rock mechanical parameters with the logging data is mainly based on interval transit time, a rock density, mud percentage content and rock porosity, and relevant calculation equations are as follows:

$${E}_{d} = \frac{{ρ}_{b}}{Δ {t}_{s}^{2}} \cdot \frac{3 Δ {t}_{s}^{2} - 4 Δ {t}_{p}^{2}}{Δ {t}_{s}^{2} - Δ {t}_{p}^{2}} , \qquad ( 1 )$$

$${μ}_{d} = \frac{Δ {t}_{s}^{2} - 2 Δ {t}_{p}^{2}}{2 ( Δ {t}_{s}^{2} - Δ {t}_{p}^{2} )} , \qquad ( 2 )$$

$$C = 0. 00544 {{ρ}_{b}^{2} ( \frac{1 + {μ}_{d}}{1 - {μ}_{d}} )}^{2} ( 1 - 2 {μ}_{d} ) ( 1 + 0.78 {V}_{s h} ) / Δ {t}_{p}^{4} , \qquad ( 3 )$$

$${S}_{c} = {E}_{d} [ 0.008 {V}_{s h} + 0.0045 ( 1 - {V}_{s h} ) ] , \qquad ( 4 )$$

$$and φ = 90 - \frac{360}{π} arctan ( 1 / \sqrt{4.73 - 0.098 Φ} ) \qquad ( 5 )$$

In equations (1)-(5), E_{d} is a dynamic Young's modulus of elasticity, in MPa, μ_{d} is a dynamic Poisson's ratio, and is dimensionless, C is cohesion, in MPa, S_{c} is compressive strength, in MPa, Vₛₕ is a mud percentage content, and is dimensionless, ρ_{b} is a rock density, in kg/m³, Δtₚ and Δtₛ are longitudinal wave offset time and transverse wave offset time respectively, in μs/ft, φ is an internal friction angle, in °, and Φ is logging porosity, in %.

With the rock mechanical parameters interpreted by the logging data as constraints, determining, by means of inversion, three-dimensional heterogeneity of the mechanical parameters of the intact rock having undeveloped fractures with a well-seismic combination method or a phase attribute modeling method, so as to build a three-dimensional heterogeneous model of the mechanical parameters of the intact rock

Step 4, building a three-dimensional discrete fracture network model by means of field observation of the fractures, and building a mathematical model between a normal stiffness coefficient and a shear stiffness coefficient of a fracture surface and a normal stress by means of a fracture surface mechanical experiment in combination with magnitudes of the mechanical parameters of the intact rock; and programming the mathematical model into a three-dimensional discrete fracture network numerical simulation program by means of computer programming, and configuring software to adjust a normal stiffness value and a shear stiffness value of the corresponding fracture surface under different normal stress conditions repeatedly in each simulation, so as to describe deformation features of the fracture surface with a self-defined fracture surface deformation constitutive model during numerical simulation of a fractured rock mass, and build a three-dimensional discrete fracture network geomechanical model including fracture mechanical features.

Step 5, building a mathematical model between fracture parameters and equivalent mechanical parameters of the rock mass by means of discrete element numerical simulation, where the fracture parameters include a fracture density, a fracture orientation and a fracture included angle, and the equivalent mechanical parameters of the rock mass refer to the rock mechanical parameters that generate the same deformation effect and rupture process as the fractured rock mass; and transforming, by means of the equivalent mechanical parameters, the discrete fracture network model into a continuous finite element model suitable for simulating a macroscopic stress field.

Step 6, on the basis of the uniaxial-triaxial and dynamic-static correction of the rock mechanical parameters and the three-dimensional heterogeneous model of the mechanical parameters of the intact rock, building a three-dimensional model of the rock mechanical stratum under the condition of the undeveloped fractures, and predicting three-dimensional distributions of a first stage of paleo-stress field and the tectonic fractures according to the three-dimensional model of the rock mechanical stratum.

Step 7, building, on the basis of modeling the rock mechanical stratum, a finite element model suitable for simulating the macroscopic stress field, and with a magnitude of the paleo-stress in the formation period of the tectonic fractures as a constraint, obtaining a paleo-tectonic stress field suitable for predicting the first stage of fractures.

Step 8, predicting a density and an orientation of the first stage of fractures according to a mathematical model between the tectonic fractures and the rock mechanical parameters and in combination with the paleo-tectonic stress field suitable for predicting the first stage of fractures; and in a three-dimensional stress field, predicting fracture occurrence according to a calculation model between the fracture occurrence and the rock mechanical parameters as well as the stress field. The calculation model between the occurrence of the fractures and the rock mechanical parameters as well as the stress field is as follows:

in numerical simulation of the stress field, a plane in which the fracture is formed has a unit normal vector of n′, a dip angle of η′, and a dip direction of γ′. According to a criterion for rock rupture, the fracture occurrence in a stress field coordinate system (σ₁, σ₂, and σ₃ directions represent 3 coordinate axis directions) is obtained, and included angles between a principal stress direction and X-Y-Z axes in a geodetic coordinate system are expressed as:

(1) included angles between σ₁ and the X-Y-Z axes are expressed as α₁₁,α₁₂,α₁₃ respectively;

(2) included angles between σ₂ and the X-Y-Z axes are expressed as α₂₁,α₂₂,α₂₃ respectively; and

(3) included angles between σ₃ and the X-Y-Z axes are expressed as α₃₁,α₃₂,α₃₃ respectively.

with shear rupture of the rock as an example, unit normal vector coordinates n″ₓ,n″_{y} and n″_{z} of two groups of fracture surfaces generated in the stress field coordinate system are expressed as

$$[ \begin{matrix}\begin{matrix}{n}_{x}^{″} \\ {n}_{y}^{″}\end{matrix} \\ {n}_{z}^{″}\end{matrix} ] = [ \begin{matrix}sin θ \\ 0 \\ cos θ\end{matrix} ] or [ \begin{matrix}\begin{matrix}{n}_{x}^{″} \\ {n}_{y}^{″}\end{matrix} \\ {n}_{z}^{″}\end{matrix} ] = [ \begin{matrix}sin θ \\ 0 \\ - cos θ\end{matrix} ] . \qquad ( 6 )$$

Three components n′ₓ, n′_{y} and n′_{z} of the vector n′ in the geodetic coordinate system are expressed as

$$[ \begin{matrix}\begin{matrix}{n}_{x}^{′} \\ {n}_{y}^{′}\end{matrix} \\ {n}_{z}^{′}\end{matrix} ] = [ \begin{matrix}cos {α}_{11} & cos {α}_{21} & cos {α}_{31} \\ cos {α}_{12} & cos {α}_{22} & cos {α}_{32} \\ cos {α}_{13} & cos {α}_{23} & cos {α}_{33}\end{matrix} ] [ \begin{matrix}\begin{matrix}{n}_{x}^{″} \\ {n}_{y}^{″}\end{matrix} \\ {n}_{z}^{″}\end{matrix} ] . \qquad ( 7 )$$

According to the equation, the dip angle η′ and the dip direction γ′ generated when the fracture is formed are calculated:

$$\{ \begin{matrix}tan {η}^{′} = \frac{\sqrt{{n}_{x}^{′2} + {n}_{y}^{′2}}}{{n}_{z}^{′}} \\ tan {γ}^{′} = \frac{{n}_{x}^{′}}{{n}_{y}^{′}}\end{matrix} \qquad ( 8 )$$

to obtain the dip angle η′ generated when the fracture is formed:

$${η}^{′} = arctan ( \frac{\sqrt{{n}_{x}^{′2} + {n}_{y}^{′2}}}{{n}_{z}^{′}} ) . \qquad ( 9 )$$

The dip direction γ′ generated when the fracture is formed is to be discussed by quadrant:

(1) under the condition of n′ₓ≤0 and n′_{y}>0, the dip direction generated when the fracture is formed is northeast, and in this case,

$${γ}^{′} = arctan ( \frac{{n}_{x}^{′}}{{n}_{y}^{′}} ) ; \qquad ( 10 )$$

(2) under the condition of n′ₓ≤0 and n′_{y}>0, the dip direction generated when the fracture is formed is southeast, and in this case,

$${γ}^{′} = arctan ( \frac{{n}_{x}^{′}}{{n}_{y}^{′}} ) + π ; \qquad ( 11 )$$

(3) under the condition of n′ₓ<0 and n′y≤0, the dip direction generated when the fracture is formed is southwest, and in this case,

$${γ}^{′} = arctan ( \frac{{n}_{x}^{′}}{{n}_{y}^{′}} ) + π ; \qquad ( 12 )$$

and

(4) under the condition of n′ₓ≤0 and n′_{y}<0, the dip direction generated when the fracture is formed is northwest, and in this case,

$${γ}^{′} = arctan ( \frac{{n}_{x}^{′}}{{n}_{y}^{′}} ) + 2 π . \qquad ( 13 )$$

In the three-dimensional stress field, predicting a three-dimensional distribution of the fracture density according to a calculation model between the fracture density and the rock mechanical parameters as well as the stress field. The calculation model between the fracture density and the rock mechanical parameters as well as the stress field is as follows:

in the simulated stress field, under the condition of (σ₁+3σ₃)>0,

$$θ = arccos [ ( {σ}_{1} - {σ}_{3} ) / 2 ( {σ}_{1} + {σ}_{3} ) ] / 2 , \qquad ( 14 )$$

$$\{ \begin{matrix}\begin{matrix}\begin{matrix}{ω}_{f} = ω - {ω}_{e} = \\ \begin{matrix}\frac{1}{2 E} [ {σ}_{1}^{2} + {σ}_{2}^{2} + {σ}_{3}^{2} - 2 μ ( {σ}_{1} + {σ}_{2} + {σ}_{3} ) - \\ {0.85}^{2} {σ}_{p}^{2} + 2 μ ( {σ}_{2} + {σ}_{3} ) 0.85 {σ}_{p}\end{matrix}\end{matrix} \\ E = {E}_{0} {σ}_{p}\end{matrix} \\ {D}_{vf} = \frac{{ω}_{f}}{J}\end{matrix} , \qquad ( 15 )$$

$$and {D}_{lf} = \frac{2 {D}_{vf} {L}_{1} {L}_{3} sin θcos θ - {L}_{1} sin θ - {L}_{3} cos θ}{{L}_{1}^{2} {sin}^{2} θ + {L}_{3}^{2} {cos}^{2} θ} ; \qquad ( 16 )$$

and

under the condition of (σ₁+3σ₃)≤0, θ=0, and a volume density of the fracture is equal to a linear density of the fracture,

in the above formulas, ω_{f} indicates a strain energy density required for a surface area of a newly added fracture, in J/m³, ω indicates a total strain energy density of the rock, in J/m³, ωₑ indicates a density of elastic strain energy to be overcome to generate the fracture, in J/m³, E indicates a Young's modulus of elasticity, in MPa, σ₁, σ₂ and σ₃ indicate a maximum effective principal stress, an intermediate effective principal stress and a minimum effective principal stress respectively, in MPa, σₚ indicates a rock rupture stress, in MPa, μ indicates a Poisson's ratio of the rock, E₀ indicates a proportional coefficient related to lithology, and is dimensionless, D_{vf} indicates the volume density of the fracture, in m²/m³, J indicates energy required to generate fractures per unit area, in J/m², D_{1f} indicates the linear density of the fracture, in line/m, L₁ and L₃ indicate lengths of a characteristic unit in directions of σ₁ and σ₃ respectively, in m, θ indicates an angle of rupture of the rock, in °, and related mechanical parameters are determined by means of a triaxial mechanical experiment of the rock.

Step 9, building a rock mechanical stratum model suitable for predicting parameters of a next stage of fractures according to the mathematical model between the tectonic fractures and the rock mechanical parameters and in combination with the density and the orientation of the first stage of fractures, executing steps 7 and 8 cyclically to quantitatively predict the paleo-stress field of N stages and the fracture parameters of the corresponding stages, and predicting the evolution law of the rock mechanical stratum of the fractured reservoir according to the mathematical model between the tectonic fractures and the rock mechanical parameters.

The present disclosure has the beneficial effects: the three-dimensional heterogeneous model of the mechanical parameters of the intact rock of a research area is built by means of a core experiment, logging calculation and seismic inversion. The three-dimensional discrete fracture network model is built by means of field observation, the mathematical model is programmed into the three-dimensional discrete fracture network numerical simulation program by means of computer programming, the software is configured to adjust the normal stiffness value and the shear stiffness value of the corresponding fracture surface under different normal stress conditions repeatedly in each simulation, so as to build the three-dimensional discrete fracture network geomechanical model including fracture mechanical features. Effects of the fracture parameters on magnitudes and anisotropy of the mechanical parameters of the fractured rock mass are analyzed by means of numerical simulation. The paleo-stress field, and the fracture density and occurrence in different periods are simulated in successive cycles in combination with a relation between the fracture parameters of a reservoir and the rock mechanical parameters as well as the stress field, and finally, a migration law of the rock mechanical stratum under the control of a tectonic factor is interpreted. The patent of the present disclosure provides the method for predicting an evolution law of a rock mechanical stratum of a fractured reservoir from perspectives of physical simulation and numerical simulation, which has a high practical value in aspects of evolution prediction of rock mechanical properties of the fractured reservoir, analysis of a formation mechanism of the fractures and fine simulation of the paleo-stress field, has low prediction cost and strong operability, and may greatly reduce expenditures of human and financial resources.

### BRIEF DESCRIPTION OF THE DRAWINGS

FIG. 1 is a flowchart of a method for predicting an evolution law of a rock mechanical stratum of a fractured reservoir;

FIG. 2 shows (A) a tectonic location in research area (modified from Darby and Ritts, 2002); (B) an east-west section of Ordos basin; and (C) a comprehensive lithologic histogram of Chang 6 oil-bearing formation in a well Yuan 284;

FIG. 3 shows a relation between a fracture strike and a principal stress orientation in a Jiyuan area of Ordos Basin (by Gao Shuai et al., 2015);

FIG. 4 shows (A) an oil reservoir crustal stress test device; and (B) a schematic diagram of sampling of a rock acoustic emission experiment;

FIG. 5 shows (A) a relation between dynamic Young's modulus and static Young's modulus of rock of Chang 6 oil-bearing formation in Yuan 284 pilot test area; and (B) a relation between dynamic Poisson's ratio and static Poisson's ratio of rock of Chang 6 oil-bearing formation in Yuan 284 pilot test area;

FIG. 6 is an observation photo of field outcrop fractures in Yanchang Formation of Shigouyi section in a western margin of Ordos Basin (a location of a field section is viewed in FIG. 1);

FIG. 7 shows (A) a three-dimensional fracture network model of western margin of Ordos Basin; and (B) a three-dimensional discrete fracture network model;

FIG. 8 shows Young's moduli and Poisson's ratios of rocks in different orientations in simulation units at different scales and different locations, where E is the Young's modulus of the rock, and μ is the Poisson's ratio of the rock (data points in different colors represent simulation results of rock mechanical parameters at different locations);

FIG. 9 shows an effect of an included angle between fractures on rock mechanical parameters;

FIG. 10 shows an effect of a Young's modulus and a density of a fracture surface of an intact rock on mechanical parameters of a fractured rock mass in a horizontal direction, where (A) is a maximum horizontal Young's modulus, (B) is a minimum horizontal Poisson's ratio, (C) is an average horizontal Young's modulus, (D) is an average horizontal Poisson's ratio, (E) is a minimum horizontal Young's modulus and (F) is a maximum horizontal Poisson's ratio;

FIG. 11 shows (A) a Yanshan geomechanical model; and (B) a Himalayan reservoir geomechanical model; and

FIG. 12 shows a prediction result of an evolution law of a rock mechanical stratum of a fractured reservoir. Yanshan period (A1-A3, B1-B3); Himalayan period (A4-A6, B4-B6); current period (A7 and B7); distribution of Young's modulus in rock mass (A1, A4 and A7), distribution of Poisson's ratio in rock (B1, B4 and B7); distribution of minimum horizontal principal stress (A2, A5), distribution of maximum horizontal principal stress (B2, B5); distribution of fracture density (A3, A6), and distribution of fracture strike (B3, B6).

### DETAILED DESCRIPTION OF THE EMBODIMENTS

The specific implementation of the present disclosure will be described below with reference to the accompanying drawings.

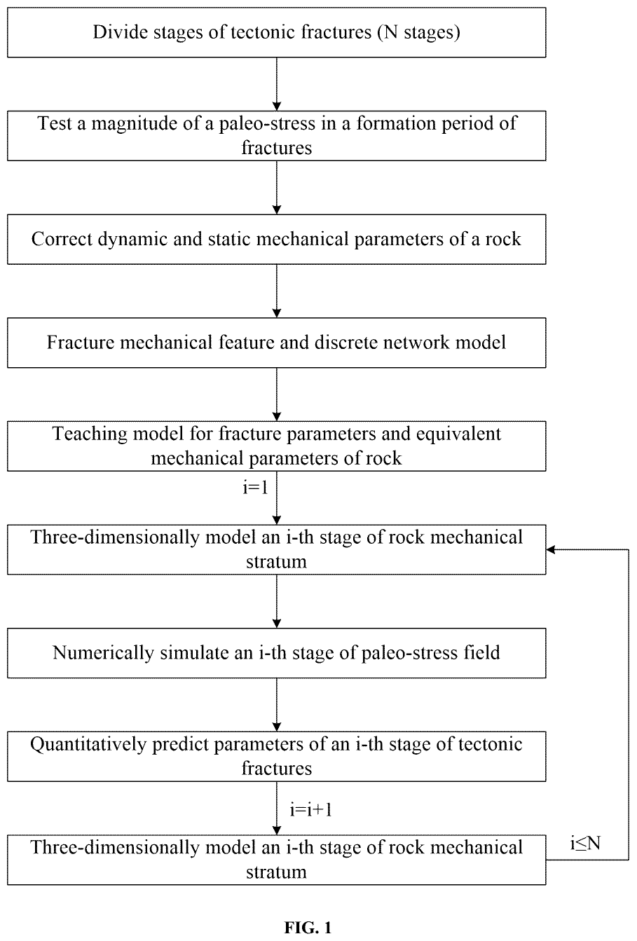

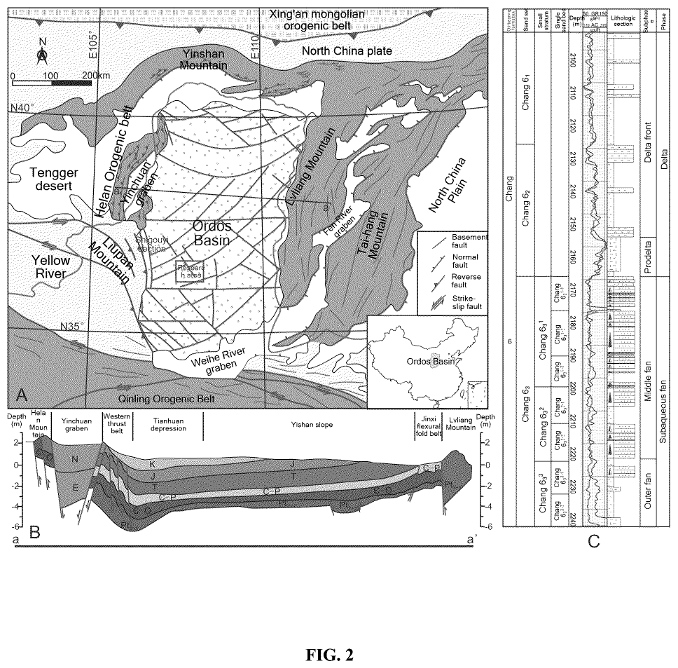

The patent of the present disclosure illustrates a specific implementation process of the present disclosure with a block Yuan 284 in a western middle section of a north Shaanxi slope in Ordos Basin as an example. The Ordos Basin is a large Mesozoic intracontinental basin superimposed on a Paleozoic craton platform in North China, is the earliest formed and longest evolved sedimentary basin in China (FIG. 2A). The basin has rich oil and gas resources and develops two sets of oil-bearing series in Mesozoic Jurassic and Triassic, as well as multiple sets of natural gas series in the Upper Paleozoic Permian, Carboniferous, and Lower Paleozoic Ordovician. Moreover, shale gas is enriched in the Mesozoic Yanchang Formation, Paleozoic Shanxi Formation and Benxi Formation. Folds and faults are relatively underdeveloped in a reservoir of the Ordos Basin (FIG. 2B). However, under the action of a regional tectonic stress, tectonic fractures at different scales are widely developed in the reservoir in the basin. Exploration and development practices show that natural fractures have a crucial effect on exploration and development of oil and gas resources, whether in a tight sandstone reservoir, a shale reservoir, or a low-permeability sandstone reservoir. The fractures have significant layer control features, and extremely stable occurrence, and are closely related to a paleo-tectonic stress field in a formation period of the fractures. The fractures at a Yanshan period are mainly in an east-west (EW) direction and a south-east-east (SEE) direction. The fractures at a Himalayan period are mainly in a north-south (NS) direction, a north-east-east (NEE) direction and a north-east (NE) direction. Affected by surface loess landform, seismic data in the basin has poor quality. On the basis that a seismic method has a great difficulty in predicting the features, a reservoir geomechanical method is an effective method for predicting tectonic fractures. Moreover, with continuous development of a method for predicting a distribution of natural fractures in a reservoir, attention has been increasingly paid to a theoretical model on which the method for predicting a distribution of natural fractures in an underground reservoir is based. That is, accuracy of a geomechanical model directly determines accuracy of simulating a stress field in a later period and predicting the fractures. A Yuan 284 pilot test area in a Huaqing area of a research area is structurally located in a central southern part of the Ordos Basin (FIG. 2A); and a Triassic Yanchang Formation of a research target horizon has a thickness ranging from 1000 m to 1300 m, and is in parallel unconformity contact with an underlying Zhifang Formation and an overlying Lower Jurassic Fuxian Formation. After years of oil and gas exploration and development practices, the Yanchang Formation is further divided into five lithologic sections and ten oil-bearing formation according to data such as lithology, lake basin evolution history, and logging stratum comparison. From a division result of typical well small layers, it may be seen that an upper part of a Chang 6₁ stratum, Chang 6₂ stratum, and Chang 6₃¹ stratum is overally in a sedimentary environment of water inflow; and the Chang 6₃³ stratum and Chang 6₃² stratum are overally in a sedimentary environment of water regression (FIG. 2C). As shown in FIG. 1, prediction steps of an evolution law of a rock mechanical stratum of a fractured reservoir in the block Yuan 284 in the western middle section of the north Shaanxi slope in the Ordos Basin are as follows:

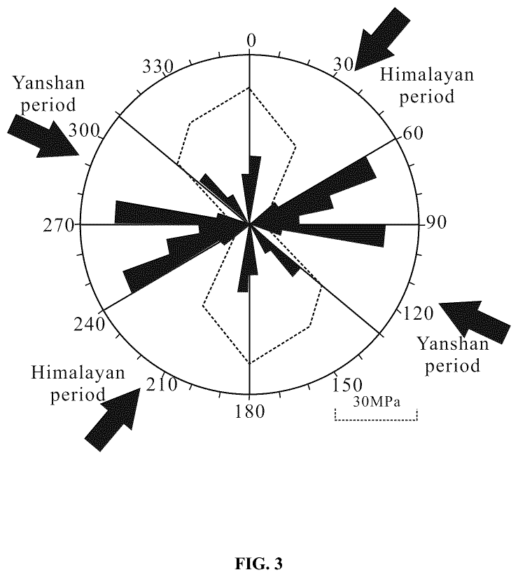

Step 1, determine a formation period of tectonic fractures with a geologic analysis and fluid geochemical method. Since core fractures in the research area are mostly unfilled fractures, the formation period of the fractures is comprehensively determined by mainly referring to a research result of a Maling area adjacent to the research area and combing evolution of a regional stress field. According to a burial-thermal evolution history of the research area, the Yanchang Formation has a ground temperature ranging from 85° C. to 116° C. during Yanshan movement IV, the Yanchang Formation having a ground temperature ranging from 70° C. to 85° C. during Himalayan movement I. Secondary saline inclusions in quartz particles in a measured rock sample have a homogeneous temperature ranging from 72° C. to 150° C., it is speculated that inclusions having a temperature ranging from 80° C. to 116° C. and 72° C. to 85° C. are formed in the Yanshan movement IV and the Himalayan Movement I respectively, which indicates that the Yanshan movement IV and the Himalayan movement I are the main formation period of the tectonic fractures in the Yanchang Formation. A majority of inclusions having a temperature ranging from 85° C. to 116° C., and therefore it is speculated that a main development period of the fractures is the Yanshan movement IV, and affected by tectonic activity intensity, the Yanshan fractures have a density greater than that of the Himalayan fractures; and the fractures in the NEE direction in the research area are mainly formed at the Himalayan period, and the fractures in the nearly EW direction are formed at the Yanshan period (FIG. 3). It is determined that formation stages of the fractures in the research area are 2 stages, i.e., N=2.

Step 2, carry out a rock acoustic emission experiment on a rock sample having undeveloped fractures, so as to determine magnitudes of a paleo-stress and a current stress in the formation period of the tectonic fractures; and measure an acoustic signal emitted from an interior of rock under a load with an acoustic emission instrument, and according to a principle of a Kaiser effect, determine a stress, i.e., a value of a crustal stress, on the rock underground on the basis that the acoustic signal generated by the rock is suddenly amplified when a stress on the rock reaches a historical maximum stress of the rock.

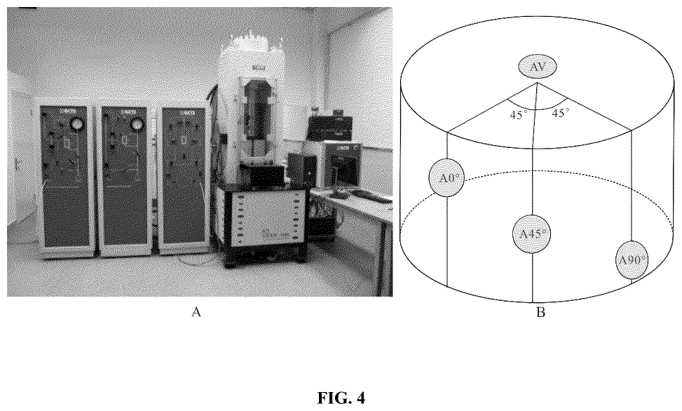

The acoustic emission experiment is completed by a crustal stress test system of an oil and gas reservoir of China Petroleum Exploration and Development Research Institute (FIG. 4A). The test system is produced by geotechnical consulting testing system (GCTS) of the United States, and may load 1500 KN axially; a loading frame has stiffness of 10 MN; a pressure chamber bears a pressure of 140 MPa and has a temperature of 150° C.; and a confining pressure may be increased to 140 MPa. As shown in FIG. 4B, a cylindrical small rock sample (Z-axis) of Φ25×50 mm in a vertical direction is drilled on a full-diameter core, and the same size of cylindrical small rock samples are drilled at 45° intervals in a plane perpendicular to a core axis. Four cylindrical small rock samples are drilled in total.

A test result of the rock acoustic emission experiment is shown in Table 1. A maximum horizontal principal stress, a minimum horizontal principal stress and a vertical principal stress of the rock sample are measured. The maximum horizontal principal stress has a gradient of about 0.020 MPa/m, the minimum horizontal principal stress has a gradient of about 0.016 MPa/m, and the vertical principal stress has a gradient of about 0.025 MPa/m. The gradients of the horizontal principal stresses are basically consistent with gradients of horizontal principal stresses of a coal reservoir in southern Ordos Basin. Crustal stresses in the research area and vicinities of the research area are increased linearly along with increase of a depth. A current maximum horizontal principal stress determined by rock acoustic emission has a distribution range ranging from 41.3 MPa to 45.3 MPa, and a current minimum horizontal principal stress by rock acoustic emission has a distribution range ranging from 33.3 MPa to 36.7 MPa; and a change of a current vertical principal stress by rock acoustic emission is mainly related to a density of the rock. On the basis of a distribution law of acoustic emission ringing numbers, it is determined that the Yanshan period has the minimum horizontal principal stress of 41.29 MPa, and the maximum horizontal principal stress of 160.58 MPa; and it is determined that the Himalayan period has the minimum horizontal principal stress of 33.18 MPa, and the maximum horizontal principal stress of 108.54 MPa.

TABLE 1
Current principal stress determined by rock acoustic emission experiment

| | | | Maximum horizontal | | Minimum horizontal | | | |
|---|---|---|---|---|---|---|---|---|
| | | | principal stress | | principal stress | | Vertical principal stress | |
| Well | Depth | | Magnitude | Gradient | Magnitude | Gradient | Magnitude | Gradient |
| number | (m) | Lithology | (MPa) | (MPa/m) | (MPa) | (MPa/m) | (MPa) | (MPa/m) |
| Yuan 410 | 2231.50 | Sandstone | 44.64 | 0.020 | 35.68 | 0.016 | 55.87 | 0.025 |
| Yuan 410 | 2246.20 | Sandstone | 45.26 | 0.020 | 36.69 | 0.016 | 57.36 | 0.026 |
| Yuan 290 | 2101.28 | Sandstone | 42.17 | 0.021 | 33.78 | 0.016 | 52.71 | 0.025 |
| Yuan 414 | 2010.15 | Sandstone | 41.34 | 0.020 | 33.30 | 0.017 | 49.14 | 0.024 |

Step 3, on the basis of a uniaxial compression experiment, a triaxial compression experiment and calculation of logging data, determine mechanical parameters of an intact rock having undeveloped fractures by means of uniaxial-triaxial and dynamic-static correction of rock mechanical parameters, thereby providing a data basis for numerical simulation of a paleo-stress field and prediction of the reservoir fractures.

The rock mechanical parameters (mainly including a Poisson's ratio of the rock, a strength parameter of the rock, various elastic moduli, an internal friction angle and cohesion) are important basic data for research on paleo-stress field simulation, current crustal stress simulation, fracture dynamic and static parameter prediction and reservoir water injection pressure. A representative rock core is selected, and the core is machined into a rock sample having a flat end surface, a diameter of 2.5 cm, and a length of 5.0 cm by utilizing apparatuses such as a drilling machine and a slicer. A triaxial compressive strength experimental instrument uses an MTS286 rock test system of China Petroleum Exploration and Development Research Institute, and is tested according to “Standard for Test Methods of Engineering Rock Masses (GB/T50266-99)”. A foundation is laid for calculation of static rock mechanical parameters from logging data by means of the built mathematical model for transforming dynamic and static rock mechanical parameters. During the triaxial compression experiment, the rock sample is put into a high-pressure chamber, and different confining pressures (0 MPa, 10 MPa, 20 MPa and 30 MPa) are applied around the rock sample. A vertical stress of the rock sample is gradually increased, and strain values of the rock sample in an axial direction and a radial direction are recorded separately to obtain corresponding rock stress-strain curves. Triaxial compression experiments are carried out on nine representative rock samples are selected for in the research, and some of test results are shown in Table 2.

TABLE 2
Data table of triaxial mechanical experiment of rock in
Chang 6 oil-bearing formation of yuan 284 pilot test area

| | | | | | Confining | | | Compressive |
|---|---|---|---|---|---|---|---|---|
| Well | | Depth | Sample | Density | pressure | Elastic modulus | Poisson's | strength |
| number | Lithology | (m) | No. | (g/cm³) | (MPa) | (×10⁴ MPa) | ratio | (MPa) |
| Yuan 290 | Sandstone | 2106.27 | H1 | 2.49 | 0 | 11.665 | 0.059 | 75.15 |
| | | | H2 | 2.39 | 10 | 22.897 | 0.237 | 130.84 |
| | | | H3 | 2.38 | 20 | 23.904 | 0.190 | 159.55 |
| | | | H4 | 2.40 | 30 | 21.352 | 0.171 | 182.25 |
| Yuan 414 | Sandstone | 2007.10 | I1 | 2.48 | 0 | 19.260 | 0.061 | 102.29 |
| | | | I2 | 2.50 | 10 | 28.468 | 0.200 | 191.39 |
| | | | I3 | 2.49 | 20 | 26.078 | 0.202 | 190.87 |
| | | | I4 | 2.50 | 30 | 29.033 | 0.105 | 244.98 |
| Yuan 284 | Mud rock | 2205.45 | J1 | 2.62 | 0 | 16.522 | 0.269 | 58.61 |
| | | | J2 | 2.62 | 10 | 21.308 | 0.216 | 93.66 |
| | | | J3 | 2.62 | 20 | 23.087 | 0.204 | 132.59 |
| | | | J4 | 2.65 | 30 | 19.535 | 0.392 | 162.26 |

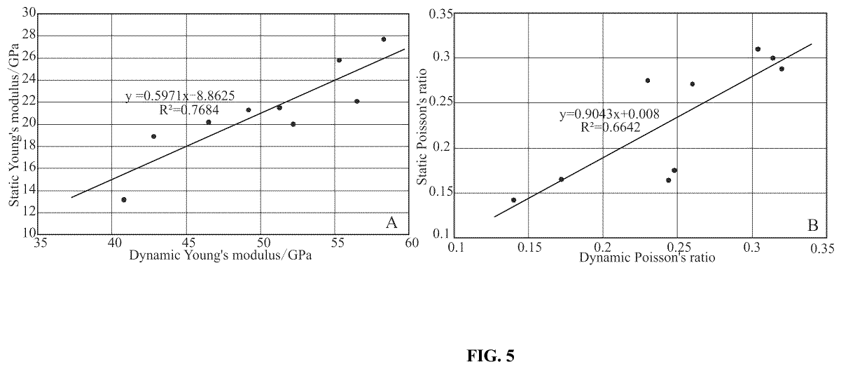

By means of calibration of dynamic mechanical parameter results of the rock mechanical experiment and logging interpretation, a dynamic-static mechanical parameter transformation model of the rock is built to obtain the static rock mechanical parameters (FIG. 5). The static mechanical parameters obtained from the equation in FIG. 5 actually do not fully consider or almost do not consider the effect of the natural fractures on the mechanical parameters. That is, the mechanical parameters obtained may be regarded as a distribution of the mechanical parameters when the natural fractures are not developed. Therefore, it is necessary to further analyze the effect of the fractures on macroscopic mechanical parameters of the rock mass and a size effect of the fractures, so as to determine a current distribution of the rock mechanical parameters, and the mechanical parameters are further used in simulation of a later stress field and numerical simulation of the current stress field.

Step 4, build a three-dimensional discrete fracture network model by means of field observation of the fractures, and build a mathematical model between a normal stiffness coefficient and a shear stiffness coefficient of a fracture surface and a normal stress by means of a fracture surface mechanical experiment; and programming the mathematical model into a three-dimensional discrete fracture network numerical simulation program by means of computer programming, and configuring software to adjust a normal stiffness value and a shear stiffness value of the corresponding fracture surface under different normal stress conditions repeatedly in each simulation, so as to describe deformation features of the fracture surface with a self-defined fracture surface deformation constitutive model during numerical simulation of a fractured rock mass, and build a three-dimensional discrete fracture network geomechanical model including fracture mechanical features.

A relation curve between a normal stress and normal displacement of the fracture surface is obtained by using the mechanical experiment of the rock, to build a mathematical model between the stress and normal displacement of the fracture surface. A normal stress-normal displacement relation of closed deformation of the fracture surface is reflected by using a power function model, and a relation between the normal stress (σₙ) and the normal displacement (Sᵥ) is expressed as

σₙ=1066.7Sᵥ^{1.4548} (17)

A relation between a normal stiffness coefficient (Kₙ) and the normal stress (σₙ) of the fracture surface is expressed as

Kₙ=120.47σₙ^{0.3126} (18)

The test results indicate that the normal stiffness coefficient of the fracture surface is increased with the increase of normal stress, and both are in a power law relationship. By measuring a shear deformation of the fracture surface corresponding to different normal stresses, a relation between a shear stiffness coefficient (Kₛ) and the normal stress (θₙ) of the fracture surface is obtained:

Kₛ=104.25σₙ^{0.4812} (19)

The mathematical model is programmed into the computer simulation program by utilizing the mathematical model between the normal stiffness coefficient and the shear stiffness coefficient of the fracture surface, and the normal stress and Fish language. The software is configured to adjust the mechanical parameters of the corresponding fracture surface (normal shear stiffness value and shear stiffness value) under different normal stress conditions in 100 steps in each simulation, so as to describe deformation features of the fracture surface with the self-defined fracture surface deformation constitutive model in the numerical simulation of the fractured rock mass.

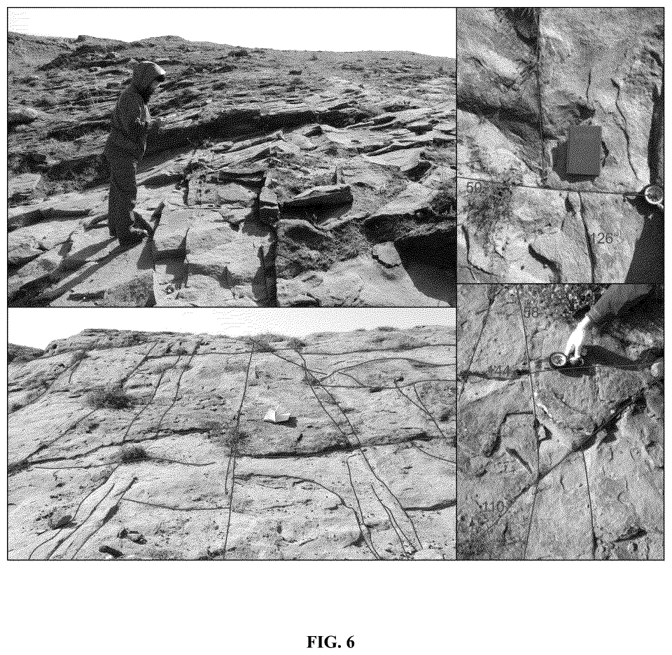

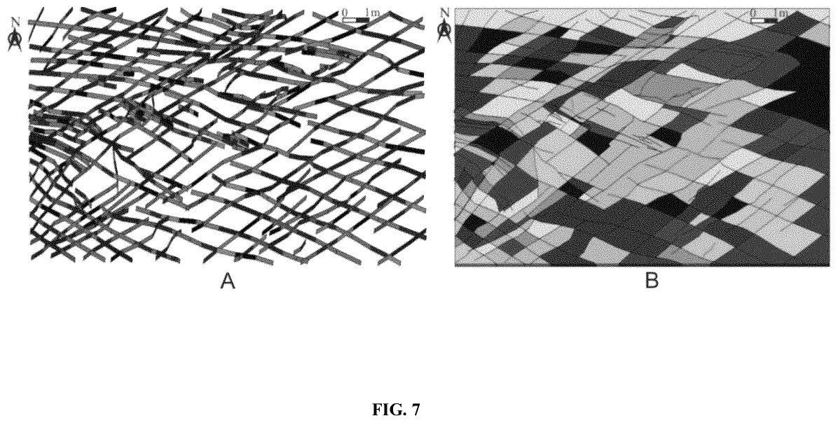

By means field observation of the fractures in the Yanchang Formation on the western margin of Ordos (FIG. 6), the three-dimensional discrete fracture network model (FIG. 7A) is built. A non-penetrating fracture network model is built in ANSYS software (FIG. 7B), and is imported into the 3DEC software. A size effect of the mechanical parameters of the complex fractured reservoir is researched on the basis of the three-dimensional discrete element method. The magnitudes of the mechanical parameters of the low-permeability sandstone reservoir are determined in combination with the triaxial mechanical experiment of the rock. An initial Young's modulus of the rock is set to 27 GPa, the Poisson's ratio is set to 0.25, and a density is set to 2.5 g/cm³ in numerical simulation.

Step 5, build a mathematical model between fracture parameters and equivalent mechanical parameters of the rock mass by means of discrete element numerical simulation, where the fracture parameters include a fracture density, a fracture orientation and a fracture included angle. The equivalent mechanical parameters refer to the rock mechanical parameters that may generate the same deformation effect and rupture process as the fractured rock mass; and transform, by means of the equivalent mechanical parameters, the discrete fracture network model into a continuous finite element model suitable for simulating a macroscopic stress field.

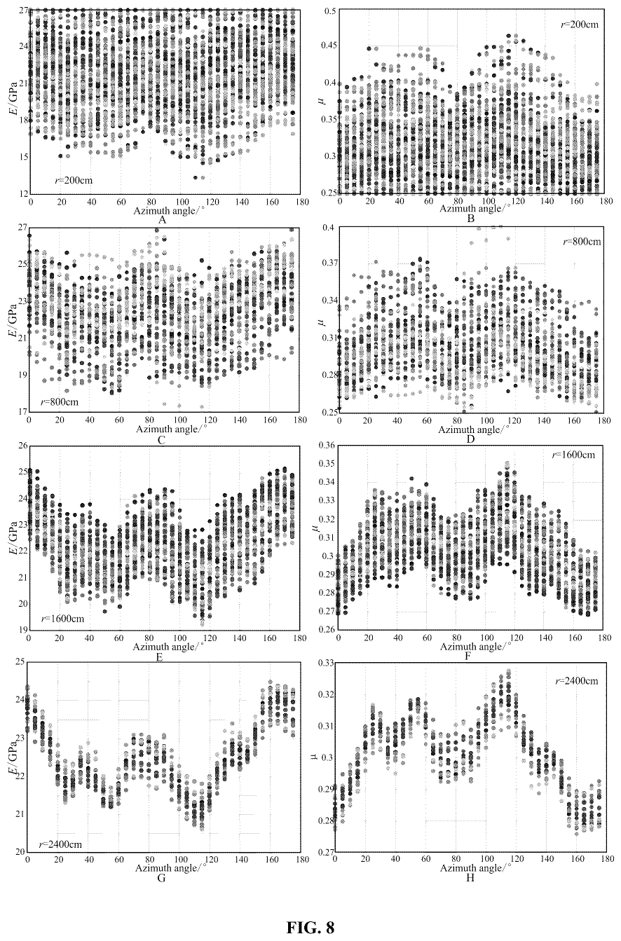

Affected by the fractures, the mechanical parameters of the reservoir are different in different directions of a simulation unit. A change law of the mechanical parameters in different directions and scales is simulated and calculated by means of a three-cycle method (FIG. 8); and when the simulation unit has a small side length, it is difficult to accurately reflect anisotropy of the mechanical parameters of the simulation unit (FIGS. 8A-D). With further increase in the side length of the simulation unit (FIGS. 8E and F, r=1600 cm), anisotropy of the mechanical parameters of the simulation unit gradually becomes clear. In a NE40°-50° direction and an SEE115° direction, the Young's modulus of the rock is relatively low; in the NS direction and the EW direction, the Young's modulus of the rock is high; a change law of the Poisson's ratio of the rock is opposite the Young's modulus; and however, in the same orientation, a range of changes in the Young's modulus and the Poisson's ratio of the rock is large. That is, there are significant differences between the mechanical parameters of the simulation unit at different positions at the scale and actual mechanical parameters. When the side length of the simulation unit is further increased (FIGS. 8G and H, r=2400 cm), the anisotropy of the mechanical parameters of the simulation unit becomes further clearer, and the mechanical parameters of the simulation unit at different positions are gradually converged in different directions. That is, the simulated mechanical parameters are further approximated to real values; and simulation results show that an excessively small mesh unit may not reflect the anisotropy of the rock mechanical parameters.

Two groups of tectonic fractures are mainly developed in the fractures of the Yanchang Formation in the western margin of the Ordos Basin, and have stable occurrence. Therefore, effects of an included angle between the fractures, the fracture density and the mechanical parameters of the intact rock on the equivalent mechanical parameters of a fractured rock mass are mainly simulated. In order to systematically analyze effect factors and evolution laws of the rock mechanical parameters, a change rate of the Young's modulus and a change rate of the Poisson's ratio are defined to describe relative changes of the rock mechanical parameters in different directions, i.e., a ratio of an equivalent Young's modulus (Poisson's ratio) of the fractured rock mass to the Young's modulus (Poisson's ratio) of the intact rock mass.

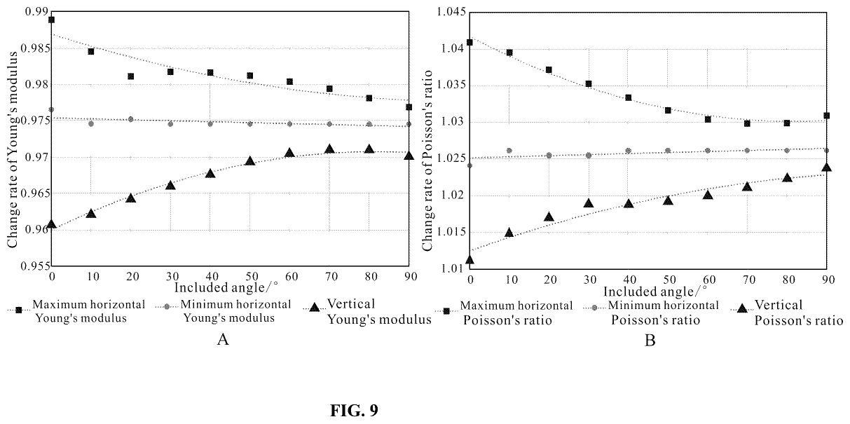

The anisotropy of the rock mechanical parameters relies on the included angle between the fractures. By building a fracture model of two sets of intersecting angles, an effect of the included angle between the fractures on the anisotropy of the rock mechanical parameters is discussed and shown in FIG. 9. As shown in FIG. 9A, there is no significant change in the minimum horizontal Young's modulus during numerical simulation with increase in the included angle between the fractures, with a change rate of about 0.975. The maximum horizontal Young's modulus is reduced with increase in the included angle between the fractures. The vertical Young's modulus is reduced with increase in the included angle between the fractures. When the included angle between the fractures is 90°, a difference between the minimum horizontal Young's modulus, the maximum horizontal Young's modulus, and the vertical Young's modulus is the smallest. As shown in FIG. 9B, a change rate of a minimum horizontal Poisson's ratio with an included angle between fractures is about 1.025, and in a vertical direction, a Poisson's ratio is increased with increase in the included angle between the fractures, which is consistent with a change law of the Young's modulus. Similarly, when the included angle between the fractures is 90°, the difference between the minimum horizontal Poisson's ratio, the maximum horizontal Poisson's ratio, and the vertical Poisson's ratio is the smallest.

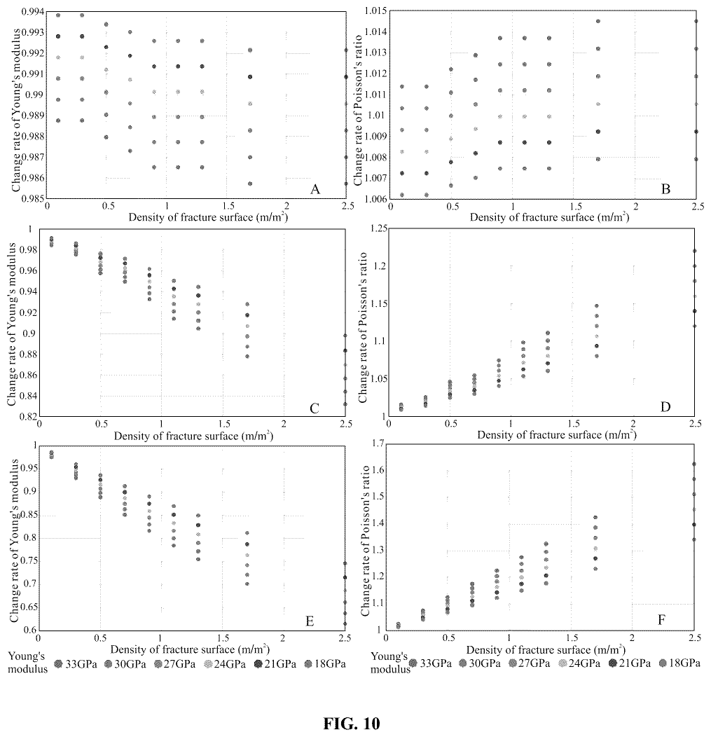

Effects of the mechanical parameters of the intact rock and a density of a fracture surface on equivalent mechanical parameters of a rock mass are simulated by changing the density of the fracture surface of a simulation unit and the Young's modulus and Poisson's ratio of the intact rock as shown in FIG. 10. As shown in FIG. 10A and FIG. 10B, an effect of a density of a fracture surface on a maximum horizontal Young's modulus and a minimum horizontal Poisson's ratio is minimum. With increase in the density of the fracture surface, a value of the maximum horizontal Young's modulus is slightly reduced. With increase in the density of the fracture surface (>1 m/m 2), an effect of the density of the fracture surface on the maximum horizontal Young's modulus is gradually reduced; with increase in the density of the fracture surface, the minimum horizontal Poisson's ratio is gradually increased; and when the density of the fracture surface is greater than 1.5 m/m 2, the density of the fracture surface has almost no effect on the minimum horizontal Poisson's ratio. As shown in FIG. 10C and FIG. 10D, effects of a density of a fracture surface on an average Young's modulus and an average Poisson's ratio are greater than that of a maximum horizontal Young's modulus and a minimum horizontal Poisson's ratio. The density of the fracture surface is linearly negatively correlated with the average Young's modulus, and linearly positively correlated with the average Poisson's ratio. As shown in FIG. 10E and FIG. 10F, a density of a fracture surface has the greatest effect on a minimum horizontal Young's modulus and a maximum horizontal Poisson's ratio. The density of the fracture surface is linearly negatively correlated with the minimum Young's modulus and is linearly positively correlated with the maximum Poisson's ratio. Simulation results show that the Poisson's ratio of an intact rock has a small effect on equivalent mechanical parameters of a simulation unit, while the Young's modulus of the intact rock has a significant effect on the equivalent mechanical parameters of the simulation unit. The greater the Young's modulus of the intact rock is, the greater the effect on the equivalent mechanical parameters of a fractured rock mass is. That is, the greater the Young's modulus of the intact rock is, the greater reduction in the equivalent Young's modulus (percentage) of the simulated rock mass is, the greater increase in the Poisson's ratio is.

Step 6, on the basis of the uniaxial-triaxial and dynamic-static correction of the rock mechanical parameters and the three-dimensional heterogeneous model of the mechanical parameters of the intact rock, build a three-dimensional model of the rock mechanical stratum under the condition of the undeveloped fractures, and predict a first stage of fractures according to three-dimensional model of the rock mechanical stratum.

Step 7, build, on the basis of modeling the rock mechanical stratum, a finite element model suitable for simulating the macroscopic stress field, when a Yanshan geomechanical model has a total thickness of 4500 m, a target stratum Chang 6₃ having a burial depth of sand bodies of 1990 m, a minimum horizontal principal stress being 41.29 MPa, and a maximum horizontal principal stress being 160.58 MPa; and with a magnitude of the paleo-stress in the formation period of the tectonic fractures as a constraint, predict a paleo-tectonic stress field suitable for predicting the first stage of fractures.

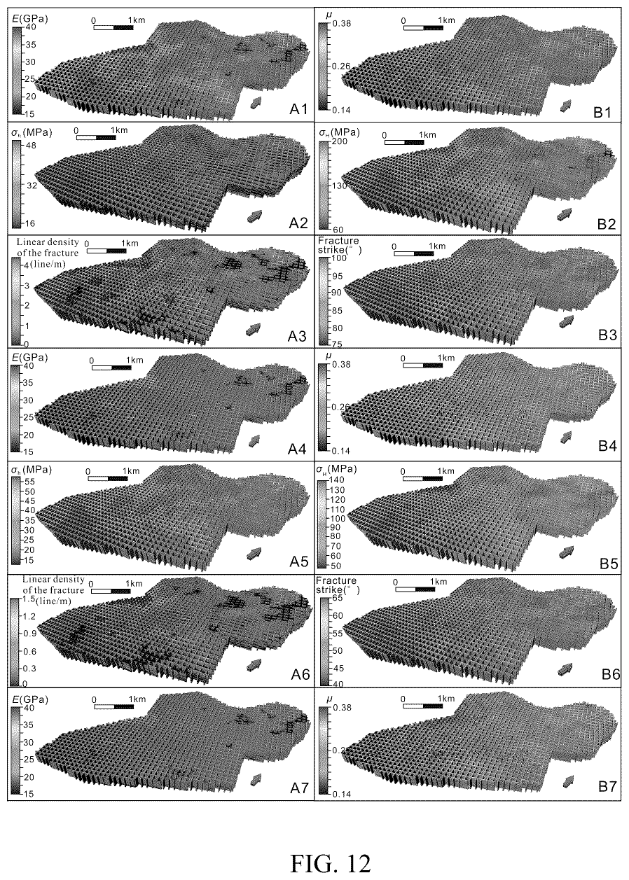

Step 8, on the basis that a vertical stratification phenomenon of the stress field is particularly obvious by means of analysis of simulation results of a stress field at the Yanshan period and a stress field at the Himalayan period in the research area, which may be a main reason for vertical stratification of current tectonic fractures, and distributions of the minimum horizontal principal stress and the maximum horizontal principal stress are closely related to distribution of the sand bodies, build a corresponding reservoir geomechanical heterogeneous model according to a built three-dimensional distribution model of the mechanical parameters of the intact rock at the Yanshan period (FIG. 12A1 and FIG. 12B1), so as to obtain a distribution of a stress field at the Yanshan period by means of simulation (FIG. 12A2 and FIG. 12B2); and predict a density and orientation of the first stage fractures according to a mathematical model between the tectonic fractures and the rock mechanical parameters as well as the stress field (FIG. 12A3 and FIG. 12B3).

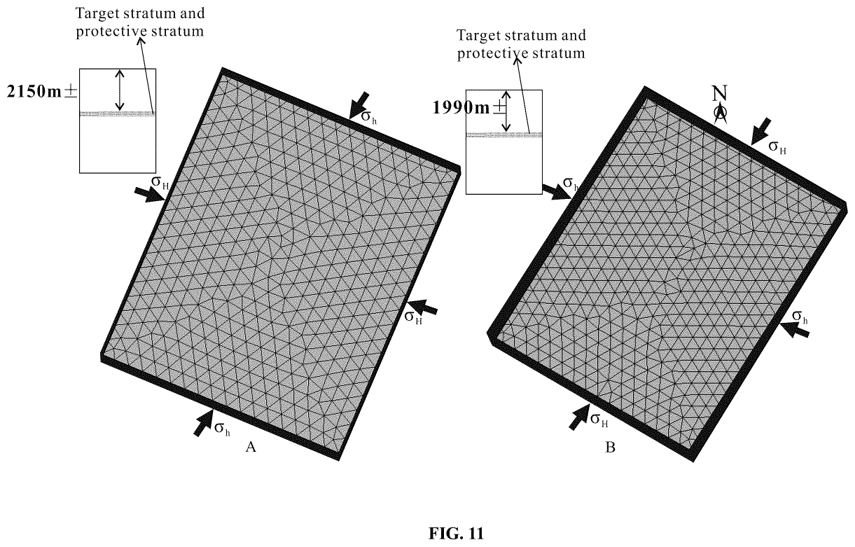

Step 9, build a rock mechanical stratum model suitable for predicting parameters of a next stage of fractures according to the mathematical model between the tectonic fractures and the rock mechanical parameters and in combination with the density and the orientation of the first stage of fractures, when a Himalayan geomechanical model has a total thickness of 4500 m, a minimum horizontal principal stress of 33.18 MPa and a maximum horizontal principal stress of 108.54 MPa, and Chang 63 has a burial depth of sand bodies of 2150 m by means of analysis of a burial history of the reservoir (FIG. 11); and execute steps 7 and 8 cyclically to quantitatively predict the paleo-stress field and the fracture parameters of different stages, and predict the evolution law of the rock mechanical stratum of the fractured reservoir.

According to a mathematical model between the equivalent mechanical parameters of the rock and the fracture parameters, the equivalent mechanical parameters of the rock mass after the fractures at the Yanshan period are obtained, and a reservoir geomechanical heterogeneous model at the Himalayan period is built (FIG. 12A4 and FIG. 12B4). A stress field at the Himalayan period is obtained by means of simulation (FIG. 12A5 and FIG. 12B5), and the density and occurrence of the fracture surface at the Himalayan period are determined (FIG. 12A6 and FIG. 12B6). The fracture parameters (occurrence, density and combination mode) at the Yanshan period and the Himalayan period are synthesized to obtain a distribution of the rock mechanical parameters of the current fractured reservoir (FIG. 12A7 and FIG. 12B7), and the reservoir geomechanical heterogeneous model is built to obtain the current crustal stress field by means of simulation.

By comparing distributions of the rock mechanical parameters at different periods (FIGS. 12A1, 12A4, 12A7, 12B1, 12B4 and 12B7), it may be obtained that the equivalent Young's modulus of the rock mass is generally reduced from the Yanshan period to the Himalayan period, and to a current period, and on the contrary, the equivalent Poisson's ratio is generally increased. A difference in the equivalent Young's modulus and Poisson's ratio of the rock mass in the Yuan 284 pilot test area is generally reduced. That is, at a location having a large Young's modulus at the Yanshan period, reduction in the Young's modulus between the Himalayan period and the current period is significant. On the contrary, in a well area having a small Young's modulus at the Yanshan period, reduction in the Young's modulus between the Himalayan period and the current period is small, and even has no change (undeveloped fractures) (FIGS. 12A1, 12A4, and 12A7). Similarly, in a well area having a small Poisson's ratio at the Yanshan period, increase in the Poisson's ratio between the Himalayan period and the current period is significant. On the contrary, at a location having a large Poisson's ratio, increase in the Poisson's ratio between the Himalayan period and the current period is small and even has no change (undeveloped fractures) (FIGS. 12B1, 12B4, and 12B7).

The present disclosure is illustrated by means of examples above, but it is not limited to the particular embodiments described above. Any modifications or variations made based on the present disclosure fall within the scope of protection of the present disclosure.

What is claimed is:

1. A method for predicting an evolution law of a rock mechanical stratum of a fractured reservoir, comprising:
step 1, determining a formation period of tectonic fractures with a geologic analysis and fluid geochemical method, and setting a stage of activity of reservoir fractures as N;
step 2, carrying out a rock acoustic emission experiment on a rock sample having undeveloped fractures, so as to determine magnitudes of a paleo-stress and a current stress in the formation period of the tectonic fractures; and measuring an acoustic signal emitted from an interior of rock under a load with an acoustic emission instrument, and determining a value of a crustal stress on the rock underground on the basis that the acoustic signal generated by the rock is suddenly amplified when a stress on the rock reaches a historical maximum stress of the rock according to a principle of a Kaiser effect;
step 3, on the basis of a uniaxial compression experiment, a triaxial compression experiment and calculation of logging data, determining mechanical parameters of an intact rock having undeveloped fractures by means of uniaxial-triaxial and dynamic-static correction of rock mechanical parameters; and with the rock mechanical parameters interpreted by the logging data as constraints, determining, by means of inversion, three-dimensional heterogeneity of the mechanical parameters of the intact rock having undeveloped fractures with a well-seismic combination method or a phase attribute modeling method, so as to build a three-dimensional heterogeneous model of the mechanical parameters of the intact rock;
step 4, building a three-dimensional discrete fracture network model by means of field observation of the fractures, and building a mathematical model between a normal stiffness coefficient and a shear stiffness coefficient of a fracture surface and a normal stress by means of a fracture surface mechanical experiment in combination with magnitudes of the mechanical parameters of the intact rock; and programming the mathematical model into a three-dimensional discrete fracture network numerical simulation program by means of computer programming, and configuring software to adjust a normal stiffness value and a shear stiffness value of the corresponding fracture surface under different normal stress conditions repeatedly in each simulation, so as to describe deformation features of the fracture surface with a self-defined fracture surface deformation constitutive model during numerical simulation of a fractured rock mass, and build a three-dimensional discrete fracture network geomechanical model comprising fracture mechanical features;
step 5, building a mathematical model between fracture parameters and equivalent mechanical parameters of the rock mass by means of discrete element numerical simulation, wherein the fracture parameters comprise a fracture density, a fracture orientation and a fracture included angle, and the equivalent mechanical parameters of the rock mass refer to the rock mechanical parameters that generate the same deformation effect and rupture process as the fractured rock mass; and transforming, by means of the equivalent mechanical parameters, the discrete fracture network model into a continuous finite element model suitable for simulating a macroscopic stress field;
step 6, on the basis of the uniaxial-triaxial and dynamic-static correction of the rock mechanical parameters and the three-dimensional heterogeneous model of the mechanical parameters of the intact rock, building a three-dimensional model of the rock mechanical stratum under the condition of the undeveloped fractures, and predicting three-dimensional distributions of a first stage of paleo-stress field and the tectonic fractures according to the three-dimensional model of the rock mechanical stratum;
step 7, building, on the basis of modeling the rock mechanical stratum, a finite element model suitable for simulating the macroscopic stress field, and with a magnitude of the paleo-stress in the formation period of the tectonic fractures as a constraint, obtaining a paleo-tectonic stress field suitable for predicting the first stage of fractures;
step 8, predicting a density and an orientation of the first stage of fractures according to a mathematical model between the tectonic fractures and the rock mechanical parameters and in combination with the paleo-tectonic stress field suitable for predicting the first stage of fractures; in a three-dimensional stress field, predicting fracture occurrence according to a calculation model between the fracture occurrence and the rock mechanical parameters as well as the stress field; and predicting a three-dimensional distribution of the fracture density according to a calculation model between the fracture density and the rock mechanical parameters as well as the stress field; and
step 9, building a rock mechanical stratum model suitable for predicting parameters of a next stage of fractures according to the mathematical model between the tectonic fractures and the rock mechanical parameters and in combination with the density and the orientation of the first stage of fractures, executing steps 7 and 8 cyclically to quantitatively predict the paleo-stress field of N stages and the fracture parameters of the corresponding stages, and predicting the evolution law of the rock mechanical stratum of the fractured reservoir according to the mathematical model between the tectonic fractures and the rock mechanical parameters.

2. The method according to claim 1, wherein
the determining a formation period of tectonic fractures with a geologic analysis and fluid geochemical method comprises carrying out, on the basis of identification and characterization research on fractures of different scales, experimental research on a fluid geochemical evidence of the activity of the reservoir fractures on the basis of multi-stage filling features of the fractures, and carrying out observation photography, microscopic temperature measurement and laser Raman spectrum test on fluid inclusions in reservoir fracture filling minerals, to determine a type, shape, phase state, abundance, salinity, composition and homogenized temperature of the fluid inclusions, Fe₂O₃, MgO, MgO₂, trace elements, carbon and oxygen isotopes, and composition and salinity of stratum water, calculating a capture pressure and density of the fluid inclusions, comparatively analyzing differences in paleo-fluid properties of different types of filling minerals, and comprehensively determining stages of the activity of the reservoir fractures in combination with an intersecting relation of fractures in different rock formations.

3. The method according to claim 1, wherein
the calculation model between the fracture occurrence and the rock mechanical parameters as well as the stress field is as follows:
in numerical simulation of the stress field, a plane in which the fracture is formed has a unit normal vector of n′, a dip angle of η′, and a dip direction of γ′; according to a criterion for rock rupture, the fracture occurrence in a stress field coordinate system is obtained, and included angles between a principal stress direction and X-Y-Z axes in a geodetic coordinate system are expressed as:
(1) included angles between σ₁ and the X-Y-Z axes are expressed as α₁₁,α₁₂,α₁₃ respectively;
(2) included angles between σ₂ and the X-Y-Z axes are expressed as α₂₁,α₂₂,α₂₃ respectively; and
(3) included angles between σ₃ and the X-Y-Z axes are expressed as α₃₁,α₃₂,α₃₃ respectively;
with shear rupture of the rock as an example, unit normal vector coordinates n″ₓ, n″_{y} and n″_{z} of two groups of fracture surfaces generated in the stress field coordinate system are expressed as
$$[ \begin{matrix}{n}_{x}^{″} \\ {n}_{y}^{″} \\ {n}_{z}^{″}\end{matrix} ] = [ \begin{matrix}sin θ \\ 0 \\ cos θ\end{matrix} ] or [ \begin{matrix}{n}_{x}^{″} \\ {n}_{y}^{″} \\ {n}_{z}^{″}\end{matrix} ] = [ \begin{matrix}sin θ \\ 0 \\ - cos θ\end{matrix} ] ; \qquad ( 6 )$$
three components n′ₓ, n′_{y} and n′_{z} of the vector n′ in the geodetic coordinate system are expressed as
$$[ \begin{matrix}{n}_{x}^{′} \\ {n}_{y}^{′} \\ {n}_{z}^{′}\end{matrix} ] = [ \begin{matrix}cos {α}_{11} & cos {α}_{21} & cos {α}_{31} \\ cos {α}_{12} & cos {α}_{22} & cos {α}_{32} \\ cos {α}_{13} & cos {α}_{23} & cos {α}_{33}\end{matrix} ] [ \begin{matrix}{n}_{x}^{″} \\ {n}_{y}^{″} \\ {n}_{z}^{″}\end{matrix} ] ; \qquad ( 7 )$$
according to the equation, the dip angle η′ and the dip direction γ′ generated when the fracture is formed are calculated:
$$\{ \begin{matrix}tan {η}^{′} = \frac{\sqrt{{n}_{x}^{′2} + {n}_{y}^{′2}}}{{n}_{z}^{′}} \\ tan {γ}^{′} = \frac{{n}_{x}^{′}}{{n}_{y}^{′}}\end{matrix} ; \qquad ( 8 )$$
to obtain the dip angle η′ generated when the fracture is formed:
$${η}^{′} = arctan ( \frac{\sqrt{{n}_{x}^{′2} + {n}_{y}^{′ 2}}}{{n}_{z}^{′}} ) ; \qquad ( 9 )$$
and
the dip direction γ′ generated when the fracture is formed is to be discussed by quadrant:
(1) under the condition of n′ₓ≤0 and n′_{y}>0, the dip direction generated when the fracture is formed is northeast, and in this case,
$${γ}^{′} = arctan ( \frac{{n}_{x}^{′}}{{n}_{y}^{′}} ) ; \qquad ( 10 )$$
(2) under the condition of n′ₓ≤0 and n′_{y}>0, the dip direction generated when the fracture is formed is southeast, and in this case,
$${γ}^{′} = arctan ( \frac{{n}_{x}^{′}}{{n}_{y}^{′}} ) + π ; \qquad ( 11 )$$
(3) under the condition of n′ₓ<0 and n′_{y}≤0, the dip direction generated when the fracture is formed is southwest, and in this case,
$${γ}^{′} = arctan ( \frac{{n}_{x}^{′}}{{n}_{y}^{′}} ) + π ; \qquad ( 12 )$$
and
(4) under the condition of n′ₓ≤0 and n′_{y}<0, the dip direction generated when the fracture is formed is northwest, and in this case,
$${γ}^{′} = arctan ( \frac{{n}_{x}^{′}}{{n}_{y}^{′}} ) + 2 π . \qquad ( 13 )$$

4. The method according to claim 1, wherein
the calculation model between the fracture density and the rock mechanical parameters as well as the stress field is as follows:
in the simulated stress field, under the condition of (σ₁+3σ₃)>0,
$$θ = arccos [ ( {σ}_{1} - {σ}_{3} ) / 2 ( {σ}_{1} + {σ}_{3} ) ] / 2 , \qquad ( 14 )$$
$$\{ \begin{matrix}\begin{matrix}\begin{matrix}{ω}_{f} = ω - {ω}_{e} = \\ \begin{matrix}\frac{1}{2 E} [ {σ}_{1}^{2} + {σ}_{2}^{2} + {σ}_{3}^{2} - 2 μ ( {σ}_{1} + {σ}_{2} + {σ}_{3} ) - \\ {0.85}^{2} {σ}_{p}^{2} + 2 μ ( {σ}_{2} + {σ}_{3} ) 0.85 {σ}_{p}\end{matrix}\end{matrix} \\ E = {E}_{0} {σ}_{p}\end{matrix} \\ {D}_{vf} = \frac{{ω}_{f}}{J}\end{matrix} , \qquad ( 15 )$$
$$and {D}_{lf} = \frac{2 {D}_{vf} {L}_{1} {L}_{3} sin θcos θ - {L}_{1} sin θ - {L}_{3} cos θ}{{L}_{1}^{2} {sin}^{2} θ + {L}_{3}^{2} {cos}^{2} θ} ; \qquad ( 16 )$$
and
under the condition of (σ₁+3σ₃)≤0, θ=0, and a volume density of the fracture is equal to a linear density of the fracture,
in the above formulas, ω_{f} indicates a strain energy density required for a surface area of a newly added fracture, in J/m³, ω indicates a total strain energy density of the rock, in J/m³, ωₑ indicates a density of elastic strain energy to be overcome to generate the fracture, in J/m³, E indicates a Young's modulus of elasticity, in MPa, σ₁, σ₂ and σ₃ indicate a maximum effective principal stress, an intermediate effective principal stress and a minimum effective principal stress respectively, in MPa, σₚ indicates a rock rupture stress, in MPA, μ indicates a Poisson's ratio of the rock, E₀ indicates a proportional coefficient related to lithology, and is dimensionless, D_{vf} indicates the volume density of the fracture, in m²/m³, J indicates energy required to generate fractures per unit area, in J/m², D_{1f} indicates the linear density of the fracture, in line/m, L₁ and L₃ indicate lengths of a characteristic unit in directions of σ₁ and σ₃ respectively, in m, θ indicates an angle of rupture of the rock, in °, and related mechanical parameters are determined by means of a triaxial mechanical experiment of the rock.
